(19) United States
(12) Patent Application Publication
(10) Pub. No.: US 2024/0142907 A1
(43) Pub. Date: May 2, 2024

(54) IMAGE FORMING APPARATUS AND SHUTDOWN METHOD AT TIME OF POWER CUT-OFF

(71) Applicant: CANON KABUSHIKI KAISHA, Tokyo (JP)

(72) Inventors: FUMITAKA SOBUE, Chiba (JP); KAZUHISA KOIZUMI, Chiba (JP); YOSUKE HATA, Chiba (JP)

(21) Appl. No.: 18/498,786

(22) Filed: Oct. 31, 2023

(30) Foreign Application Priority Data
Oct. 31, 2022 (JP) 2022-174097

(51) Int. Cl. G03G 15/00; G03G 15/20

(52) U.S. Cl. CPC G03G 15/5004; G03G 15/205; G03G 2215/00983

(57) ABSTRACT

An image forming apparatus includes a first power cord configured to supply a first power, a second power cord configured to supply a second power, a first monitor configured to monitor a supply state of the first power, a second monitor configured to monitor a supply state of the second power, a load to which either the first power or the second power can be supplied, a controller configured to control an operation of the load, and a switcher configured to be switched between a first state in which the first power is supplied to the controller and a second state in which the second power is supplied to the controller.

### BACKGROUND

### Field

The present disclosure relates to an image forming apparatus to which power is supplied from a plurality of power supply systems.

### Description of the Related Art

In an image forming apparatus, there are growing demands for an increase in the number of printed sheets per unit time (printing speed). In order to increase the printing speed, it is required to increase a conveying speed of a recording material to be printed and raise a fixing temperature of a fixing device that fixes an image to the recording material. Power consumption tends to increase as a result of each of these demands.

For power cords used for electrical apparatuses, a maximum value of power that can be safely used (rated power) is defined. The value of the rated power varies from country to country. For example, in Japan, power cords used for electrical apparatus have a rated power of 1,500 W because of a voltage of 100 V and a current of 15 A. When an image forming apparatus requires more power, a special power cord that can be used at a voltage of 100 V and a current of 20 A, single-phase 200 V, three-phase 200 V, or the like is required. In this case, power supply construction work is required on a facility side as well. However, in a rental office building or the like, it is required to install an image forming apparatus without performing related power supply construction work. For that reason, some image forming apparatus that require a power of 1,500 W or more include a plurality of power cords with the rated power and operate through use of power supplied from the respective power cords.

When an image forming apparatus includes a plurality of power cords, there is a possibility that a power plug of any one of the power cords may be disconnected from an outlet or a circuit breaker of a power source to which any one of the power cords is connected may be tripped. In such a case, there is a possibility that the image forming apparatus may fail to operate normally due to cut-off of power supply to some loads. In Japanese Patent Application Laid-open No. 2007-316245, there is disclosed an image forming apparatus that discontinues operation and notifies a user of a caution in a case where power supply from a power cord to which an AC load is connected is cut off.

In general, in a case where power supply from a power source to an image forming apparatus is to be cut off normally, various kinds of shutdown processing are performed, and then the power supply from the power source is cut off. Examples of the shutdown processing include delivery of a recording material remaining on a conveying path and cleaning of toner remaining on a photosensitive drum or an intermediate transfer belt. Image forming apparatus include parts that are to fail in a case where shutdown is not performed normally. For example, in a case where rotation of an intermediate transfer belt is stopped at a timing at which rotation of photosensitive drums has not been stopped, the intermediate transfer belt may be pulled by the photosensitive drums and damaged. There is also a possibility that, unless power supply is cut off after a fixing device has been sufficiently cooled, peripheral parts of the fixing device may be destroyed due to heat accumulated in a casing.

However, disconnection of a power cord and tripping of a circuit breaker suddenly occur, and timings thereof cannot be controlled. Therefore, there is a possibility that the shutdown processing may fail to be performed normally depending on a timing at which power supply is cut off.

### SUMMARY

Various embodiments of the present disclosure have been made in view of the above-mentioned problems, and have an object of providing an image forming apparatus capable of performing normal shutdown processing even when power supply is suddenly cut off. An image forming apparatus according to one embodiment of the present disclosure includes a first power cord configured to supply a first power, a second power cord configured to supply a second power, a first monitor configured to monitor a supply state of the first power, a second monitor configured to monitor a supply state of the second power, a load to which either the first power or the second power can be supplied, a controller configured to control an operation of the load, and a switcher configured to be switched between a first state in which the first power is supplied to the controller and a second state in which the second power is supplied to the controller, wherein the controller is configured to stop, in a case where the switcher is in the first state and it is detected that the supply of the first power has been ceased based on a monitoring result obtained by the first monitor, the operation of the load, switch a connection state of the switcher to the second state, supply the second power to the load, and perform a process associated with cut-off of the first power.

Further, according to the present disclosure, a shutdown method to be executed by an apparatus at a time of power cut-off, is provided, the apparatus including: a first power cord configured to supply a first power; a second power cord configured to supply a second power; a first monitor configured to monitor a supply state of the first power; a second monitor configured to monitor a supply state of the second power; a load to which either the first power or the second power can be supplied; a controller configured to control an operation of the load; and a switcher configured to be switched between a first state in which the first power is supplied to the controller and a second state in which the second power is supplied to the controller, the shutdown method includes stopping, by the controller, in a case where the switcher is in the first state and it is detected that the supply of the first power has been ceased based on a monitoring result obtained by the first monitor, the operation of the load, switching a connection state of the switcher to the second state, supplying the second power to the load, and performing a process associated with cut-off of the first power.

Further features of the present disclosure will become apparent from the following description of exemplary embodiments (with reference to the attached drawings).

### BRIEF DESCRIPTION OF THE DRAWINGS

FIG. 1 is a configuration diagram of an image forming apparatus.

FIG. 2 is an explanatory diagram of power supply systems of the image forming apparatus.

FIG. 3 is an explanatory diagram of a configuration of a first switcher.

FIG. 4 is a flow chart for illustrating shutdown processing at a time of power cut-off.

FIG. 5 is a flow chart for illustrating a power cut-off operation.

FIG. 6 is an explanatory diagram of power supply systems of an image forming apparatus.

FIG. 7A and FIG. 7B are explanatory diagrams of a configuration of an AC switcher.

FIG. 8 is a flow chart for illustrating shutdown processing at a time of power cut-off.

### DESCRIPTION OF THE EMBODIMENTS

Preferred embodiments of the present disclosure are illustratively described in detail below with reference to the drawings. In the following description, like components are denoted by like reference symbols.

### First Embodiment

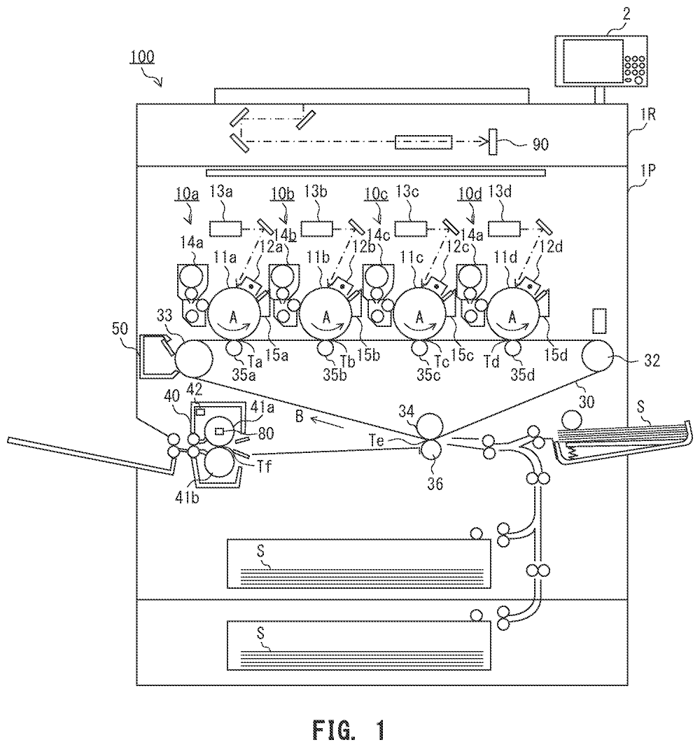

FIG. 1 is a configuration diagram of an image forming apparatus according to a first embodiment of the present disclosure. An image forming apparatus 100 according to the first embodiment includes a reader 1R, a printer 1P, and an operating device 2. The reader 1R is provided above the printer 1P. The operating device 2 is provided above the reader 1R.

The operating device 2 is a user interface including an input interface and an output interface. The input interface includes various key buttons and a touch panel. The output interface includes a display and a speaker. A user can input instructions, data, and the like through the input interface of the operating device 2. The operating device 2 can cause the output interface to output a screen for showing a state of the image forming apparatus 100 and a setting screen for inputting an instruction, data, and the like.

The reader 1R is an image reading apparatus that optically reads an image from an original, and includes an image sensor 90. The reader 1R irradiates an image printing surface of the original placed on an original table with light from a light source, and causes the image sensor 90 to receive light reflected by the original through reflecting mirrors. The image sensor 90 converts the reflected light received from the original into signals of each of red (R), green (G), and blue (B) color components through use of color filters. The image sensor 90 generates, based on those respective color signals, image signals of yellow (Y), magenta (M), cyan (C), and black (K) color components.

The reader 1R performs such original reading processing as described above, for example, in a case where the user presses a copy button of the operating device 2 after the original is placed on the original table. The reader 1R transmits, to the printer 1P, the image signals of yellow (Y), magenta (M), cyan (C), and black (K) color components that have been generated by the original reading processing.

The printer 1P includes a plurality of (in the first embodiment, four) image forming units 10a, 10b, 10c, and 10d for forming images of mutually different colors and an intermediate transfer belt 30. The respective image forming units 10a, 10b, 10c, and 10d form the images of the corresponding colors based on the image signals of the corresponding color components. The intermediate transfer belt 30 has an endless belt shape, and has the images of the respective colors transferred thereonto from the image forming units 10a, 10b, 10c, and 10d. The image forming units 10a, 10b, 10c, and 10d are arranged side by side along one side of the intermediate transfer belt 30.

The image forming unit 10a forms an image of yellow. The image forming unit 10b forms an image of magenta. The image forming unit 10c forms an image of cyan. The image forming unit 10d forms an image of black. The image forming units 10a, 10b, 10c, and 10d have the same configuration and operate in the same manner. The following description is given of the configuration of the image forming unit 10a, and description of the configurations of the other image forming units 10b, 10c, and 10d is omitted.

The image forming unit 10a includes a photosensitive drum 11a, a charging device 12a, an exposure device 13a, a developing device 14a, a primary transfer roller 35a, and a drum cleaner 15a. The photosensitive drum 11a is a drum-shaped photosensitive member having a photosensitive layer on a surface thereof, and is driven to rotate in a direction indicated by an arrow A. The charging device 12a uniformly charges the photosensitive layer of the rotating photosensitive drum 11a. The exposure device 13a forms an electrostatic latent image on the photosensitive layer of the photosensitive drum 11a by irradiating the uniformly charged photosensitive layer of the photosensitive drum 11a with laser light based on the image signal of yellow. The developing device 14a develops the electrostatic latent image formed on the photosensitive drum 11a through use of a yellow developer (toner) to form a toner image of yellow on the photosensitive layer of the photosensitive drum 11a.

The primary transfer roller 35a is arranged so as to be opposed to the photosensitive drum 11a across the intermediate transfer belt 30, and presses the photosensitive drum 11a. The primary transfer roller 35a transfers the toner image of yellow borne on the photosensitive drum 11a onto the intermediate transfer belt 30. A portion in which the primary transfer roller 35a presses the photosensitive drum 11a with the intermediate transfer belt 30 interposed therebetween is referred to as “primary transfer nip portion Ta.” A portion in which a primary transfer roller 35b presses a photosensitive drum 11b with the intermediate transfer belt 30 interposed therebetween is referred to as “primary transfer nip portion Tb.” A portion in which a primary transfer roller 35c presses a photosensitive drum 11c with the intermediate transfer belt 30 interposed therebetween is referred to as “primary transfer nip portion Tc.” A portion in which a primary transfer roller 35d presses a photosensitive drum 11d with the intermediate transfer belt 30 interposed therebetween is referred to as “primary transfer nip portion Td.”

In the same manner, a toner image of magenta is formed on the surface of the photosensitive drum 11b of the image forming unit 10b. A toner image of cyan is formed on the surface of the photosensitive drum 11c of the image forming unit 10c. A toner image of black is formed on the surface of the photosensitive drum 11d of the image forming unit 10d. The primary transfer rollers 35b, 35c, and 35d transfer the toner images of magenta, cyan, and black borne on the photosensitive drums 11b, 11c, and 11d, respectively, onto the intermediate transfer belt 30 so that the toner images of the respective colors are superimposed on the toner image of yellow. Thus, the intermediate transfer belt 30 bears the toner images of all the colors. The toner remaining on the photosensitive drums 11a, 11b, 11c, and 11d after the transfer is collected by the drum cleaners 15a, 15b, 15c, and 15d, respectively.

The intermediate transfer belt 30 is stretched around a drive roller 32, a driven roller 33, and a secondary transfer opposing roller 34, and is driven to rotate in a direction indicated by an arrow B by rotation of the drive roller 32. Timings at which the toner images are transferred from the respective image forming units 10a, 10b, 10c, and 10d are adjusted based on a rotational speed of the intermediate transfer belt 30 and the intervals between the photosensitive drums 11a to 11d so that the toner images of the respective colors are superimposed on one another. A belt cleaner 50 is provided so as to be opposed to the driven roller 33 across the intermediate transfer belt 30.

The intermediate transfer belt 30 rotates to convey the toner images of the respective colors borne thereon to the secondary transfer opposing roller 34. A secondary transfer roller 36 is provided so as to be opposed to the secondary transfer opposing roller 34 across the intermediate transfer belt 30. A portion in which the secondary transfer roller 36 presses the secondary transfer opposing roller 34 with the intermediate transfer belt 30 interposed therebetween is referred to as “secondary transfer nip portion Te.” The secondary transfer roller 36 nips and conveys a recording material S, such as a sheet, between the secondary transfer roller 36 and the intermediate transfer belt 30 at the secondary transfer nip portion Te, to thereby collectively transfer the toner images of the respective colors from the intermediate transfer belt 30 onto the recording material S. The belt cleaner 50 collects the toner remaining on the intermediate transfer belt 30 after the transfer. The recording material S is fed from a sheet feeding cassette or a manual feed tray to the secondary transfer nip portion Te.

A fixing device 40 is provided on downstream of the secondary transfer roller 36 in a conveyance direction of the recording material S. The secondary transfer roller 36 conveys the recording material S onto which the toner images have been transferred to the fixing device 40. The fixing device 40 includes a fixing roller 41a including a built-in fixing heater 80, a fixing belt 41b, and a thermistor 42. The fixing roller 41a is pressed by the fixing belt 41b to form a fixing nip portion Tf. The fixing device 40 fixes an image to the recording material S by heat-melting the toner images and applying pressure thereto while the recording material S is nipped and conveyed at the fixing nip portion Tf. The recording material S on which the image has been fixed is delivered outside the image forming apparatus 100 as a printed product.

The thermistor 42 detects a temperature (fixing temperature) at which the fixing device 40 heats the toner image. Through adjustment of a heat generation amount of the fixing heater 80 based on a detection result of the temperature obtained by the thermistor 42, the fixing temperature is maintained at an optimum temperature for fixing the image.

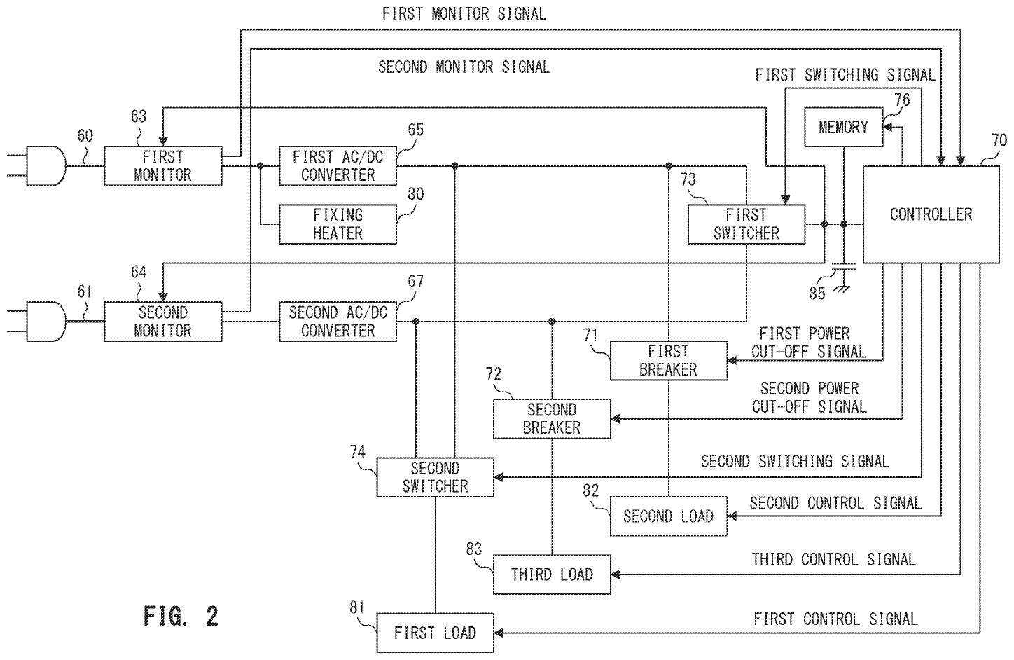

FIG. 2 is an explanatory diagram of power supply systems of the image forming apparatus 100. The image forming apparatus 100 according to the first embodiment is supplied with power from a commercial power source through a plurality of (in this case, two) power cords (first power cord 60 and second power cord 61). The power cords (first power cord 60 and second power cord 61) each have a power plug that is inserted into and removed from an outlet, and it is possible to supply power to the image forming apparatus 100 by inserting the power plugs into the outlets.

The first power cord 60 and the second power cord 61 supply power to mutually different loads. Now, a case in which power is supplied to a first load 81, a second load 82, a third load 83, and the fixing heater 80 is described as an example. Power can be supplied to the first load 81 from any one of the first power cord 60 or the second power cord 61. Power is supplied to the second load 82 through the first power cord 60. Power is supplied to the third load 83 through the second power cord 61. Power is supplied to the fixing heater 80 through the first power cord 60.

An input state of the power supplied through the first power cord 60 is monitored by a first monitor 63. An input state of the power supplied through the second power cord 61 is monitored by a second monitor 64. The first monitor 63 is connected to a first AC/DC converter 65, the fixing heater 80, and a controller 70. The first AC/DC converter 65 is connected to a first breaker 71, a first switcher 73, and a second switcher 74. The first breaker 71 is connected to the second load 82. The second monitor 64 is connected to a second AC/DC converter 67 and the controller 70. The second AC/DC converter 67 is connected to a second breaker 72, the first switcher 73, and the second switcher 74. The second breaker 72 is connected to the third load 83. The second switcher 74 is connected to the first load 81.

The controller 70 is connected to a memory 76. The controller 70 can transmit a signal to the first monitor 63, the second monitor 64, the first breaker 71, the second breaker 72, the first switcher 73, the second switcher 74, the first load 81, the second load 82, and the third load 83. A storage battery 85 is provided to a connection line between the controller 70 and the first switcher 73. The controller 70 controls operations of the first breaker 71, the second breaker 72, the first switcher 73, the second switcher 74, the first load 81, the second load 82, and the third load 83.

The first monitor 63 and the second monitor 64 perform power monitoring by, for example, generating a zero-cross signal from an AC waveform of the input power and monitoring a generation interval of the zero-cross signal. When the zero-cross signal has not been generated for a predetermined time period, the first monitor 63 and the second monitor 64 determine that the input of the supplied power has been cut off. A first monitor signal, which is a monitoring result obtained by the first monitor 63, is transmitted to the controller 70. A second monitor signal, which is a monitoring result obtained by the second monitor 64, is transmitted to the controller 70 in the same manner. The controller 70 detects occurrence or non-occurrence of cut-off of the power based on the first monitor signal and the second monitor signal, and controls the operation of each component depending on a detection result thereof.

Power for operating the first monitor 63 and the second monitor 64 is supplied from a subsequent stage of the first switcher 73. A purpose thereof is to prevent a situation in which, in a case where the power supply from the first power cord 60 or the second power cord 61 is ceased, the power is no longer supplied to the first monitor 63 or the second monitor 64 and the power monitoring cannot be performed.

The power for operating the first monitor 63 and the second monitor 64 may be supplied from a subsequent stage of the second switcher 74. In this case, it is required to satisfy a condition that output voltages (DC voltages) of the first AC/DC converter 65 and the second AC/DC converter 67 do not reach or fall below a predetermined value until a switching operation of the second switcher 74 is completed after the power cut-off from the first power cord 60 or the second power cord 61 is detected. In order to prevent the output voltages (DC voltages) of the first AC/DC converter 65 and the second AC/DC converter 67 from reaching or falling below the predetermined value, it is required to provide, for example, a storage battery such as a capacitor in the subsequent stage of the second switcher 74.

The power (AC power) input from the first power cord 60 to the first AC/DC converter 65 through the first monitor 63 is converted into DC power by the first AC/DC converter 65. The power (AC power) input from the first power cord 60 is also supplied to the fixing heater 80 through the first monitor 63. The power (AC power) input from the second power cord 61 to the second AC/DC converter 67 through the second monitor 64 is converted into DC power by the second AC/DC converter 67. The DC voltage output from the first AC/DC converter 65 is supplied to the first switcher 73, the second switcher 74, and the first breaker 71. The DC voltage output from the second AC/DC converter 67 is supplied to the first switcher 73, the second switcher 74, and the second breaker 72.

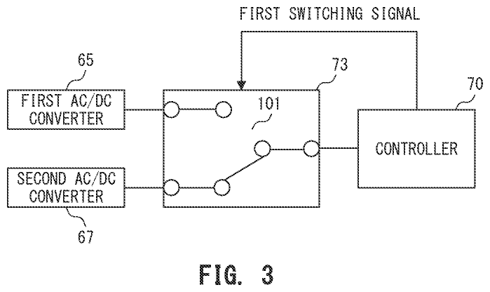

The first switcher 73 can supply power to the controller 70 through the storage battery 85. FIG. 3 is an explanatory diagram of the configuration of the first switcher 73. The first switcher 73 includes a switch 101 that is switched between a power supply line from the first AC/DC converter 65 to the controller 70 and a power supply line from the second AC/DC converter 67 to the controller 70. The switch 101 receives input of power from the first AC/DC converter 65 and the second AC/DC converter 67, and has output connected to the controller 70. In an initial state, the first switcher 73 is in a state of connecting the second AC/DC converter 67 and the controller 70 to each other. The switch 101 has the connection state controlled by a first switching signal input from the controller 70. The switch 101 may be formed of a mechanical component such as a relay or a semiconductor component such as a field effect transistor (FET). The first switcher 73 has the state controlled by the first switching signal input from the controller 70, and is switched to a configuration in which power is supplied from the first AC/DC converter 65 to the controller 70.

The storage battery 85 is provided in order to supply power to the controller 70, in a case where the power supply from the second power cord 61 is ceased, until the controller 70 switches the first switcher 73 to the power supply line from the first AC/DC converter 65. The storage battery 85 is formed of a capacitor, a super capacitor, a battery, or the like and is charged with electric power from the first AC/DC converter 65. The storage battery 85 can supply power until the voltage supplied from the second AC/DC converter 67 falls below an operable voltage of the controller 70.

The second switcher 74 is connected to the first load 81. The second switcher 74 has a switch similar to that of the first switcher 73. The switch receives input of power from the first AC/DC converter 65 and the second AC/DC converter 67, and has output connected to the first load 81. In an initial state, the second switcher 74 is configured to supply power from the second AC/DC converter 67 to the first load 81. The second switcher 74 has the state controlled by a second switching signal input from the controller 70, and is switched to a configuration in which power is supplied from the first AC/DC converter 65 to the first load 81.

The first breaker 71 is connected to the second load 82. In an initial state, the first breaker 71 connects the first AC/DC converter 65 and the second load 82 to each other. The first breaker 71 has the state controlled by a first power cut-off signal input from the controller 70, and is configured to disconnect the first AC/DC converter 65 and the second load 82 from each other. Through disconnection between the first AC/DC converter 65 and the second load 82, the DC power output from the first AC/DC converter 65 is no longer supplied to the second load 82. The second breaker 72 operates in the same manner as the first breaker 71 to control the supply of the DC power from the second AC/DC converter 67 to the third load 83.

The operation of the first load 81 is controlled by a first control signal input from the controller 70. The operation of the second load 82 is controlled by a second control signal input from the controller 70. The operation of the third load 83 is controlled by a third control signal input from the controller 70. The first load 81, the second load 82, and the third load 83 are each illustrated as a single load in FIG. 2, but in practice, may each be a combination of a plurality of loads.

The first load 81 is a load that may cause a failure due to sudden stoppage of the image forming apparatus 100 during operation. For example, in a configuration in which excess heat of the fixing device 40 is exhausted by a fan, in a case where the power is suddenly cut off while the fixing device 40 is sufficiently warm, the fan suddenly stops and the heat cannot be exhausted. This causes heat to build up in the fixing device 40, and may result in a temperature overshoot. Depending on the overshooting temperature, heat-resistant temperatures of various components (not shown) inside the fixing device 40 may be exceeded, thereby causing a failure. In such a configuration, the fan of the fixing device 40 corresponds to the first load 81.

Further, the first load 81 may be a motor that performs a contacting operation and a releasing operation for each of various rollers. For example, in a case where the photosensitive drums 11a to 11d are left in contact with the intermediate transfer belt 30 at the primary transfer nip portions Ta to Td for a long period of time, there occurs a phenomenon that the intermediate transfer belt 30 is deformed into shapes of the photosensitive drums 11a to 11d. This causes unevenness on the intermediate transfer belt 30, and affects image formation. A similar phenomenon may occur at the secondary transfer nip portion Te and the fixing nip portion Tf of the fixing device 40. As another example, the first load 81 may be the operating device 2 that informs the user of the state of the image forming apparatus 100 and prompts the user to take appropriate measures.

The second load 82 and the third load 83 are other loads, and the power supplied from the first power cord 60 and the second power cord 61 is approximately equally distributed thereto. Depending on the distribution of the power, a load for eliminating an event that does not lead to a failure but requires an operation of the user for recovery after the power cut-off may be connected to the first load 81. This load corresponds to, for example, a motor for conveying the recording material S in order to eject the jammed recording material S.

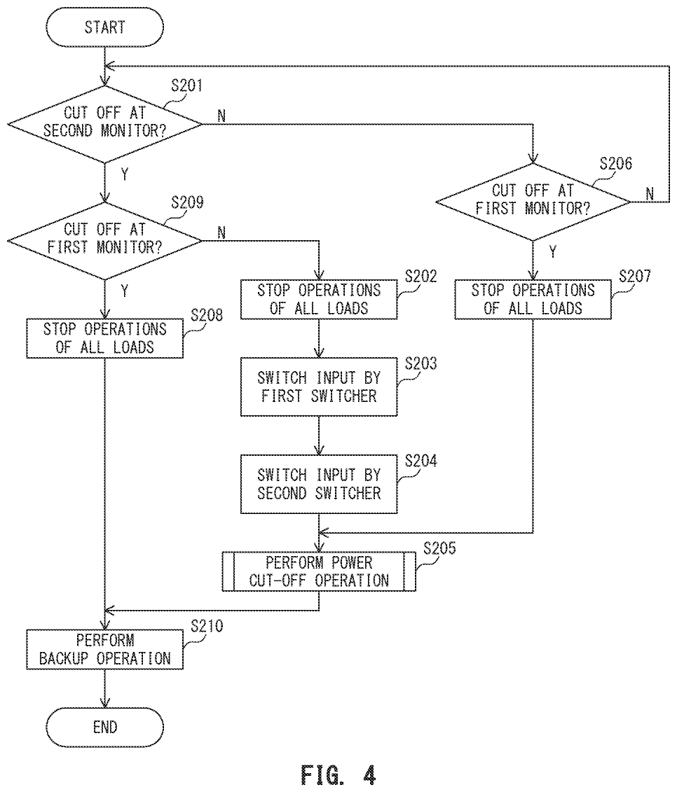

FIG. 4 is a flow chart for illustrating shutdown processing at a time of power cut-off. In the image forming apparatus 100, the first monitor 63 and the second monitor 64 start to monitor power supply states of the first power cord 60 and the second power cord 61 from a timing at which a main power switch (not shown) is operated to start power supply. In the first embodiment, the controller 70 examines the monitoring result obtained by the first monitor 63 after having examined the monitoring result obtained by the second monitor 64.

The controller 70 detects the occurrence or non-occurrence of the cut-off of the power supplied through the second power cord 61 based on the second monitor signal acquired from the second monitor 64 (Step S201). When the cut-off of the power supplied through the second power cord 61 is detected (Y in Step S201), the controller 70 detects the occurrence or non-occurrence of the cut-off of the power supplied through the first power cord 60 based on the first monitor signal acquired from the first monitor 63 (Step S209). When the cut-off of the power supplied through the first power cord 60 is detected (Y in Step S209), the controller 70 brings the operations of all the loads to an emergency stop (Step S208).

Immediately after the charges in the storage battery 85 have been exhausted, the power supply to the controller 70 that has brought the operations of all the loads to an emergency stop is ceased. For that reason, the controller 70 performs a backup operation of leaving a log in the memory 76 before the power supply from the storage battery 85 is ceased (Step S210). The log contains, for example, information of a job being output, progress of the job, and the fact that the power supply from both the first power cord 60 and the second power cord 61 has been cut off.

When the cut-off of the power supplied through the first power cord 60 is not detected (N in Step S209), the controller 70 brings the operations of all the loads to an emergency stop (Step S202). The operations of all the loads are stopped because each load is affected in a case in which the loads that are operated by the power from the first power cord 60 to which the power supply continues are kept operating in a case where the loads that are operated by the power from the second power cord 61 to which the power supply has been ceased are brought to a stop. For example, in a case in which power is supplied from the first power cord 60 and the second power cord 61 to a plurality of motors that drive a plurality of rollers conveying the recording material S, in a case where the power supply from the second power cord 61 is cut off, there are motors that are brought to a stop and motors that are kept operating. In this case, the roller driven by the operating motor pushes the recording material S onto the roller driven by the stopped motor. This may cause the recording material S to be pushed in an accordion manner. In order to prevent such a situation, the operations of all the loads are stopped.

Further, for example, in a case in which power is supplied from the first power cord 60 to the motors that drive the photosensitive drums 11a to 11d and power is supplied from the second power cord 61 to the motor that drives the drive roller 32 for the intermediate transfer belt 30, each motor is affected as well. In this case, the motors that drive the photosensitive drums 11a to 11d operate to keep the photosensitive drums 11a to 11d rotating, but the motor for driving the intermediate transfer belt 30 is brought to a stopped state. This may cause the photosensitive drums 11a to 11d to push the intermediate transfer belt 30, thereby damaging the intermediate transfer belt 30.

The controller 70 transmits the first switching signal to the first switcher 73 so that power is supplied from the first power cord 60 before the power supply from the storage battery 85 is ceased (Step S203). Thus, the first switcher 73 has the connection state switched, and connects the first AC/DC converter 65 and the controller 70 to each other. Subsequently, the controller 70 transmits the second switching signal to the second switcher 74 so that power is supplied from the first power cord 60 to the first load 81 (Step S204). Thus, the second switcher 74 has the connection state switched, and connects the first AC/DC converter 65 and the first load 81 to each other. After that, the controller 70 performs a power cut-off operation described later (Step S205). After the power cut-off operation is completed, the controller 70 performs the backup operation of leaving the log in the memory 76 (Step S210).

When the cut-off of the power supplied through the second power cord 61 is not detected (N in Step S201), the controller 70 detects the occurrence or non-occurrence of the cut-off of the power supplied through the first power cord 60 based on the first monitor signal acquired from the first monitor 63 (Step S206). When the cut-off of the power supplied through the first power cord 60 is not detected (N in Step S206), the power is supplied normally through the first power cord 60 and the second power cord 61. In this case, the controller 70 returns the process to Step S201, and continues to detect the occurrence or non-occurrence of the cut-off of the power supplied through the second power cord 61.

When the cut-off of the power supplied through the first power cord 60 is detected (Y in Step S206), the controller 70 brings the operations of all the loads to an emergency stop (Step S207). After that, the controller 70 performs the power cut-off operation described later (Step S205). After the power cut-off operation is completed, the controller 70 performs the backup operation of leaving the log in the memory 76 (Step S210). When power is supplied through the second power cord 61 and power is not supplied through the first power cord (N in Step S201 and Y in Step S206), the connection states of the first switcher 73 and the second switcher 74 are not to be changed. This is because the power is supplied from the second power cord 61 to the controller 70 and the first load 81 in the initial state.

The first switcher 73 and the second switcher 74 in the first embodiment have the initial state set to a state of providing electrical continuity to the second AC/DC converter 67 side, but depending on the distribution of the power, may have the initial state set to a state of providing electrical continuity to the first AC/DC converter 65 side. In that case, in a case where the cut-off of the power supplied from the first power cord 60 is detected, the connection states of the first switcher 73 and the second switcher 74 are switched in the processing steps of Step S203 and Step S204, respectively.

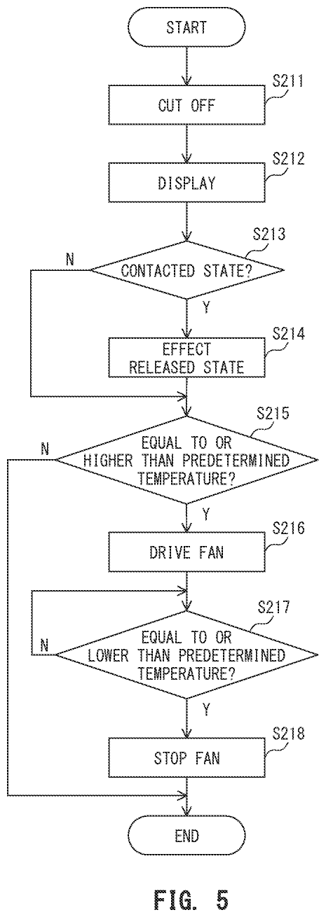

FIG. 5 is a flow chart for illustrating the power cut-off operation of Step S205. With reference to FIG. 5, the operation of the first load 81 at the time of power cut-off is described.

The controller 70 transmits the first power cut-off signal to the first breaker 71 and transmits a second power cut-off signal to the second breaker 72, to thereby cut off the power supply to the second load 82 and the third load 83 (Step S211). When the first breaker 71 is brought to a cut-off state by the first power cut-off signal, the power supply from the first AC/DC converter 65 to the second load 82 is cut off. When the second breaker 72 is brought to a cut-off state by the second power cut-off signal, the power supply from the second AC/DC converter 67 to the third load 83 is cut off. In the first embodiment, the power supply to the second load 82 and the third load 83 is cut off by the first breaker 71 and the second breaker 72. When the second control signal and the third control signal are used to directly stop the operations of the second load 82 and the third load 83, to thereby be able to reduce power consumption and to secure power enough to prevent the power cut-off operation from being hindered, the first breaker 71 and the second breaker 72 are not required to be provided. The second load 82 and the third load 83 are thus shut down.

The controller 70 that has cut off the power supply to the second load 82 and the third load 83 performs display indicating the power supply from any one of the first power cord 60 or the second power cord 61 has been cut off on the operating device 2 (Step S212). Through such display, the controller 70 prompts the user to examine a state of a circuit breaker of a facility and whether or not the power plug of the image forming apparatus 100 is disconnected from the outlet.

The controller 70 examines a contacted state of a motor for contact and release, which is classified as the first load 81 (Step S213). The motor for contact and release is, for example, a motor that brings the primary transfer rollers 35a to 35d into a contacted state so as to form the primary transfer nip portions Ta to Te with respect to the photosensitive drums 11a to 11d. The contacted state is a state in which the photosensitive drums 11a to 11d have been brought into contact with the intermediate transfer belt 30 by the primary transfer rollers 35a to 35d.

In a case of being in a contacted state (Y in Step S213), the controller 70 causes the motor that brings the primary transfer rollers 35a to 35d into a contacted state to control the primary transfer rollers 35a to 35d to be brought into a released state (Step S214). This effects a state (released state) in which the photosensitive drums 11a to 11d are spaced apart from the intermediate transfer belt 30.

In a case of not being in the contacted state (N in Step S213) or after control for effecting a released state, the controller 70 examines a temperature of the fixing device 40 based on the detection result obtained by the thermistor 42. The controller 70 determines whether or not the examined temperature is equal to or higher than a predetermined temperature (Step S215). When the fan (not shown) stops, the heat cannot be exhausted, and hence the temperature of the fixing device 40 may cause an overshoot and exceed the heat-resistant temperatures of components in the periphery. The predetermined temperature is set equal to or lower than those heat-resistant temperatures.

When the temperature is equal to or higher than the predetermined temperature (Y in Step S215), the controller 70 starts to drive the fan (Step S216). The controller 70 continues monitoring the temperature of the fixing device 40 even after the fan starts to be driven until the temperature reaches or falls below the predetermined temperature (N in Step S217). When the temperature of the fixing device reaches or falls below the predetermined temperature (Y in Step S217), the controller 70 stops the fan, and ends the power cut-off operation (Step S218).

When the temperature is not equal to or higher than the predetermined temperature (N in Step S215), the controller 70 ends the power cut-off operation.

Through such stopping processing (shutdown) after the power cut-off, even when the power supply from any one of the power cords is suddenly ceased, it is possible to suppress a failure in the image forming apparatus 100 and to safely stop the operation. Through safe stopping of the operation, the image forming apparatus 100 can also perform a recovery operation normally.

### Second Embodiment

A configuration of the image forming apparatus 100 according to a second embodiment of the present disclosure is the same as the configuration of the image forming apparatus 100 according to the first embodiment illustrated in FIG. 1. The image forming apparatus 100 according to the second embodiment differs from that according to the first embodiment in the configuration of the power supply systems.

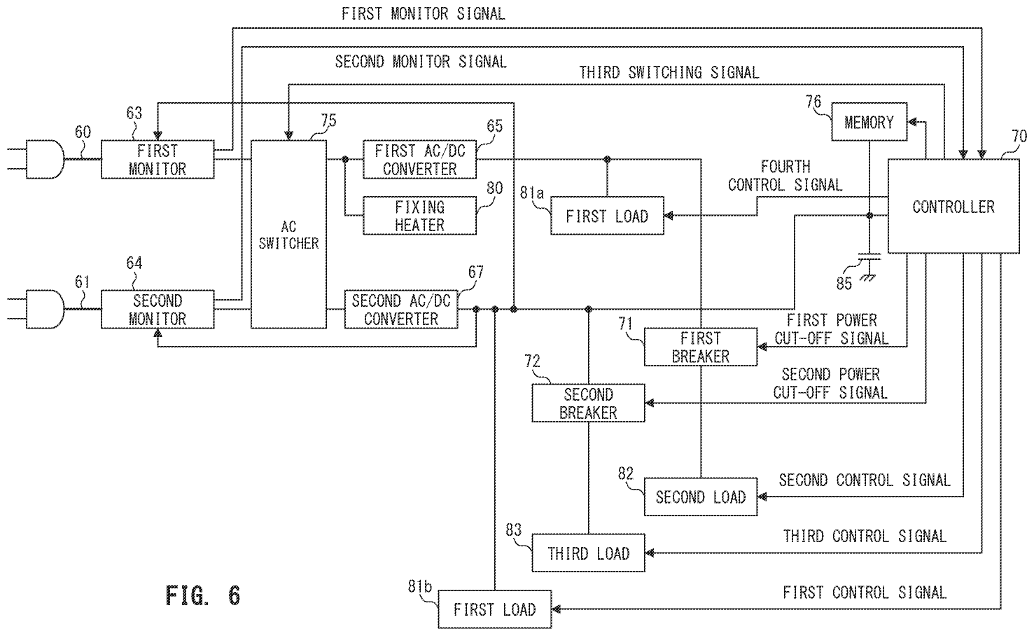

FIG. 6 is an explanatory diagram of the power supply systems of the image forming apparatus 100 according to the second embodiment. Differences from the power supply systems in the first embodiment illustrated in FIG. 2 are described. In the power supply systems in the second embodiment, the first switcher 73 and the second switcher 74 in the first embodiment are not provided. Instead, an AC switcher 75 is provided between the first monitor 63 and second monitor 64 and the first AC/DC converter 65 and second AC/DC converter 67. The first load 81 in the first embodiment is divided into a first load 81a and a first load 81b. The first load 81a is provided on the power supply line from the first AC/DC converter 65 to the controller 70. The first load 81b is provided on the power supply line from the second AC/DC converter 67 to the controller 70.

The power (AC power) supplied from the first power cord 60 through the first monitor 63 at a time of normal operation passes through the AC switcher 75 and is then converted into DC power by the first AC/DC converter 65. In addition, the power (AC power) supplied from the first power cord 60 through the first monitor 63 at the time of normal operation passes through the AC switcher 75 to be input to the fixing heater 80. The power (AC power) supplied from the second power cord 61 through the second monitor 64 at the time of normal operation passes through the AC switcher 75 and is then converted into DC power by the second AC/DC converter 67.

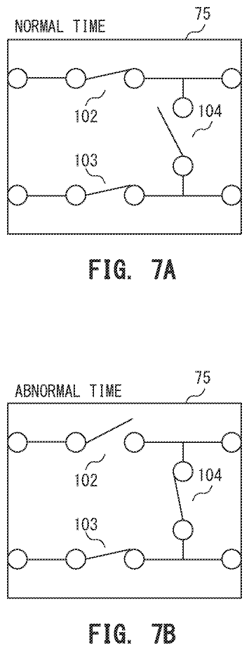

FIG. 7A and FIG. 7B are explanatory diagrams of a configuration of the AC switcher 75. The AC switcher 75 includes switches 102, 103, and 104. The switch 102 is provided on the power supply line from the first power cord 60. The switch 103 is provided on the power supply line from the second power cord 61. The switch 104 is provided between the power supply line from the first power cord 60 and the power supply line from the second power cord 61. The switches 102, 103, and 104 of the AC switcher 75 each have the connection state switched by a third switching signal transmitted from the controller 70.

The switches 102, 103, and 104 are in a state illustrated in FIG. 7A at the time of normal operation. That is, the switches 102 and 103 are in a conducting state, and the switch 104 is in a cut-off state (non-conducting state). Thus, the first power cord 60 is in a conducting state with respect to the first AC/DC converter 65 and the fixing heater 80. Further, the second power cord 61 is in a conducting state with respect to the second AC/DC converter 67.

When it is detected that the power supply from the first power cord 60 has been ceased based on the monitoring result obtained by the first monitor 63, the controller 70 transmits the third switching signal to the AC switcher 75. The AC switcher 75 switches the switch 102 to a cut-off state based on the third switching signal, and then switches the switch 104 to a conducting state. FIG. 7B is an illustration of that state.

The above-mentioned state occurs due to tripping of the circuit breaker on the first power cord 60 side or disconnection of the power plug of the first power cord 60 from the outlet. In a case of the tripping of the circuit breaker, in a case where the switch 104 is brought to a conducting state while the switch 102 remains connected, power is supplied from the second power cord 61 side to other devices connected to the circuit breaker on the first power cord 60 side. This leads to a possibility that the circuit breaker connected to the second power cord 61 side may be tripped as well. In order to avoid this situation, in a case where the power supply from the first power cord 60 is ceased, it is required to first switch the switch 102 to a cut-off state and then switch the switch 104 to a conducting state.

The case in which the power supply from the first power cord 60 has been ceased is described above, but the same applies to a case in which the power supply on the second power cord 61 side has been ceased, and it is required to first switch the switch 103 to a cut-off state and then switch the switch 104 to a conducting state.

Power for operating the first monitor 63 and the second monitor 64 is supplied from a subsequent stage of the second AC/DC converter 67. A purpose thereof is to prevent a situation in which, in a case where the power supply from the first power cord 60 is ceased, the power supply to the first monitor 63 or the second monitor 64 is ceased and the power monitoring cannot be performed.

The power for operating the first monitor 63 may be supplied from a subsequent stage of the first AC/DC converter 65. In this case, it is required to satisfy a condition that the output voltage (DC voltage) of the first AC/DC converter 65 does not reach or fall below a predetermined value until a switching operation of the AC switcher 75 is completed after the power cut-off from the first power cord 60 is detected. In order to prevent the output voltage (DC voltage) of the first AC/DC converter 65 from reaching or falling below the predetermined value, it is required to provide, for example, a storage battery such as a capacitor in the subsequent stage of the first AC/DC converter 65.

The DC power output from the first AC/DC converter 65 is supplied to the first load 81a and the first breaker 71. The DC power output from the second AC/DC converter 67 is supplied to the first load 81b, the second breaker 72, the storage battery 85, and the controller 70.

The storage battery 85 is provided in order to supply power to the controller 70, in a case where the power supply from the second power cord 61 is ceased, until the controller 70 switches the connection state of the AC switcher 75. In this case, the controller 70 switches the switch 103, which is connected to the second power cord 61 that has ceased the power supply, to a cut-off state, and then switches the switch 104 to a conducting state. Thus, the power supplied from the first power cord 60 is supplied to the controller 70. The storage battery 85 is formed of a capacitor, a super capacitor, a battery, or the like. The storage battery 85 can supply power until the voltage supplied from the second AC/DC converter 67 falls below an operable voltage of the controller 70.

The operations of the first breaker 71 and the second breaker 72 are as described in the first embodiment with reference to FIG. 2. The operation of the first load 81a is controlled by the first control signal input from the controller 70. The operation of the first load 81b is controlled by a fourth control signal input from the controller 70. The operation of the second load 82 is controlled by the second control signal input from the controller 70. The operation of the third load 83 is controlled by the third control signal input from the controller 70.

The first load 81a and the first load 81b are loads that may cause a failure due to the sudden stoppage of the image forming apparatus 100 during operation. In the same manner as in the first embodiment, the first load 81a and the first load 81b are each, for example, the fan of the fixing device 40, the motor that performs the contacting operation and the releasing operation for each of various rollers, or the operating device 2. The second load 82 and the third load 83 are other loads, for example, loads that are unlikely to cause a failure irrespective of the sudden stoppage of the image forming apparatus 100 during operation.

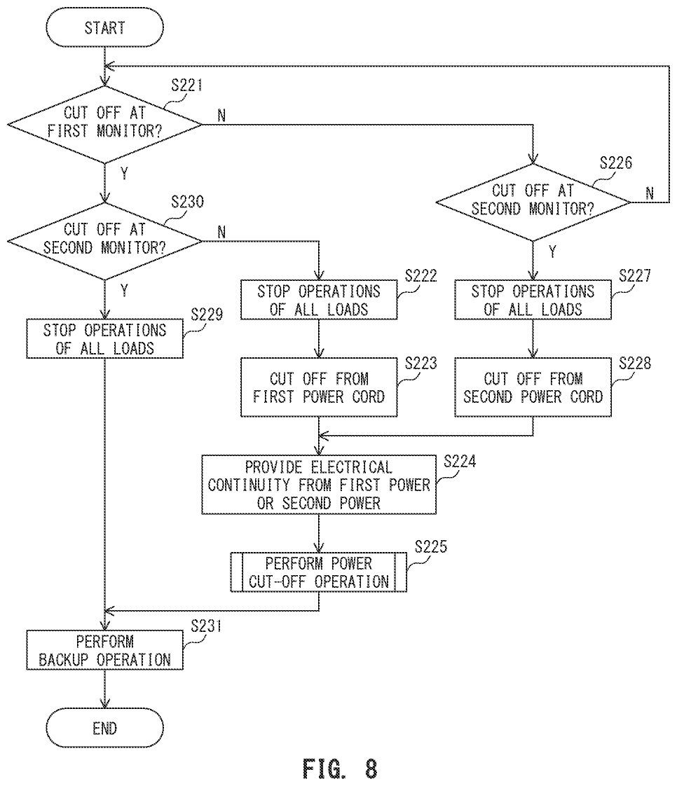

FIG. 8 is a flow chart for illustrating shutdown processing at a time of power cut-off in the second embodiment. In the image forming apparatus 100, the first monitor 63 and the second monitor 64 start to monitor power supply states of the first power cord 60 and the second power cord 61 from a timing at which the main power switch (not shown) is operated to start power supply. In the second embodiment, the controller 70 examines the monitoring result obtained by the second monitor 64 after having examined the monitoring result obtained by the first monitor 63.

The controller 70 detects the occurrence or non-occurrence of the cut-off of the power supplied through the first power cord 60 based on the first monitor signal acquired from the first monitor 63 (Step S221). When the cut-off of the power supplied through the first power cord 60 is detected (Y in Step S221), the controller 70 detects the occurrence or non-occurrence of the cut-off of the power supplied through the second power cord 61 based on the second monitor signal acquired from the second monitor 64 (Step S230). When the cut-off of the power supplied through the second power cord 61 is detected (Yin Step S230), the controller 70 brings the operations of all the loads to an emergency stop (Step S229).

Immediately after the charges in the storage battery 85 have been exhausted, the power supply to the controller 70 that has brought the operations of all the loads to an emergency stop is ceased. For that reason, the controller 70 performs a backup operation of leaving a log in the memory 76 (Step S231). The log contains, for example, information of a job being output, progress of the job, and the fact that the power supplied from both the first power cord 60 and the second power cord 61 has been cut off.

When the cut-off of the power supplied through the second power cord 61 is not detected (N in Step S230), the controller 70 brings the operations of all the loads to an emergency stop (Step S222). The operations of all the loads are stopped for the same reason as in the first embodiment. That is, for example, each load is affected in a case in which the loads that are operated by the power from the first power cord 60 to which the power supply continues are kept operating in a case where the loads that are operated by the power from the second power cord 61 to which the power supply has been ceased are brought to a stop. Before the power supply from the storage battery 85 is ceased, the controller 70 switches the switch 102 of the AC switcher 75 to a cut-off state to cut off the power from the first power cord 60 (Step S223). Subsequently, the controller 70 switches the switch 104 of the AC switcher 75 to a conducting state to enable the power supply from the second power cord 61 to the loads to which power is originally supplied from the first power cord 60 (Step S224). After that, the controller 70 performs the power cut-off operation of FIG. 5 (Step S225). After the power cut-off operation is completed, the controller 70 performs the backup operation of leaving the log in the memory 76 (Step S231).

When the cut-off of the power supplied through the first power cord 60 is not detected (N in Step S221), the controller 70 detects the occurrence or non-occurrence of the cut-off of the power supplied through the second power cord 61 based on the second monitor signal acquired from the second monitor 64 (Step S226). When the cut-off of the power supplied through the second power cord 61 is not detected (N in Step S226), the power is supplied normally through the first power cord 60 and the second power cord 61. In this case, the controller 70 returns the process to Step S221, and continues to detect the occurrence or non-occurrence of the cut-off of the power supplied through the first power cord 60.

When the cut-off of the power supplied through the second power cord 61 is detected (Y in Step S226), the controller 70 brings the operations of all the loads to an emergency stop (Step S227). After that, the controller 70 switches the switch 103 of the AC switcher 75 to a cut-off state to cut off the power from the second power cord 61 (Step S228). Subsequently, the controller 70 switches the switch 104 of the AC switcher 75 to a conducting state to enable the power supply from the first power cord 60 to the loads to which power is originally supplied from the second power cord 61 (Step S224). After that, the controller 70 performs the power cut-off operation of FIG. 5 (Step S225). After the power cut-off operation is completed, the controller 70 performs the backup operation of leaving the log in the memory 76 (Step S231).

Through such stopping processing (shutdown) after the power cut-off, even when the power supply from any one of the power cords is suddenly ceased, it is possible to suppress a failure in the image forming apparatus 100 and to safely stop the operation. Through safe stopping of the operation, the image forming apparatus 100 can also perform a recovery operation normally.

In the image forming apparatus 100 according to each of the first and second embodiments described above, in a case where a failure has occurred in the power cord supplying power to the controller 70 and the power can no longer be supplied, the other power cord is used to supply power to the controller 70. When the power can no longer be supplied, the controller 70 is operated by the storage battery 85, and switches the connection state of the first switcher 73 or the AC switcher 75 so that the power supply is enabled by the other power cord. After that, the controller 70 performs the power cut-off operation, to thereby perform normal shutdown processing for the loads. In this manner, even in a case where the power supply is suddenly cut off, the image forming apparatus 100 can shut down the loads safely and normally.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-174097, filed Oct. 31, 2022, which is hereby incorporated by reference herein in its entirety.

What is claimed is:

1. An image forming apparatus comprising:
a first power cord configured to supply a first power;
a second power cord configured to supply a second power;
a first monitor configured to monitor a supply state of the first power;
a second monitor configured to monitor a supply state of the second power;
a load to which either the first power or the second power can be supplied;
a controller configured to control an operation of the load; and
a switcher configured to be switched between a first state in which the first power is supplied to the controller and a second state in which the second power is supplied to the controller,
wherein the controller is configured to stop, in a case where the switcher is in the first state and it is detected that the supply of the first power has been ceased based on a monitoring result obtained by the first monitor, the operation of the load, switch a connection state of the switcher to the second state, supply the second power to the load, and perform a process associated with cut-off of the first power.

2. The image forming apparatus according to claim 1,
wherein the switcher is configured to supply the first power to the controller and the load in the first state, and supply the second power to the controller and the load in the second state, and
wherein the controller is configured to switch the connection state of the switcher to the second state, to thereby supply the second power to the load.

3. The image forming apparatus according to claim 2,
wherein the switcher includes a first switcher connected to the controller and a second switcher connected to the load, and
wherein the controller is configured to stop, in a case where the switcher is in the first state and it is detected that the supply of the first power has been ceased based on the monitoring result obtained by the first monitor, the operation of the load, switch a connection state of the first switcher to the second state, and switch a connection state of the second switcher to the second state.

4. The image forming apparatus according to claim 3, further comprising a power storage configured to supply power to the controller in a case where the supply of the first power is ceased,
wherein the controller is configured to switch the connection state of the first switcher to the second state before the power supply from the power storage is ceased.

5. The image forming apparatus according to claim 3,
wherein the first switcher includes a switch configured to receive input of the first power and the second power and to have output connected to the controller, and
wherein the second switcher includes a switch configured to receive input of the first power and the second power and to have output connected to the load.

6. The image forming apparatus according to claim 3, further comprising:
a first AC/DC converter configured to convert the first power into DC power; and
a second AC/DC converter configured to convert the second power into DC power,
wherein the first switcher is configured to receive input of the first power converted into the DC power by the first AC/DC converter and the second power converted into the DC power by the second AC/DC converter, and
wherein the second switcher is configured to receive input of the first power converted into the DC power by the first AC/DC converter and the second power converted into the DC power by the second AC/DC converter.

7. The image forming apparatus according to claim 1,
wherein the load includes a first load provided on a power supply line of the first power and a second load provided on a power supply line of the second power,
wherein the switcher includes a first switch provided on the power supply line of the first power, a second switch provided on the power supply line of the second power, and a third switch provided between the power supply line of the first power and the power supply line of the second power, and
wherein the controller is configured to stop, in a case where the switcher is in the first state and it is detected that the supply of the first power has been ceased based on the monitoring result obtained by the first monitor, the operation of the load, switch the first switch to a cut-off state, and then switch the third switch to a conducting state, to thereby switch the connection state of the switcher to the second state to supply the second power to the load.

8. The image forming apparatus according to claim 7, further comprising a power storage configured to supply power to the controller in a case where the supply of the first power is ceased,
wherein the controller is configured to switch the first switch to the cut-off state before the power supply from the power storage is ceased.

9. The image forming apparatus according to claim 7, wherein the controller is configured to stop, in a case where it is detected that the supply of the second power has been ceased based on a monitoring result obtained by the second monitor, the operation of the load, switch the second switch to the cut-off state, and then switch the third switch to the conducting state, to thereby switch the connection state of the switcher to the first state to supply the first power to the load.

10. The image forming apparatus according to claim 7, further comprising:
a first AC/DC converter configured to convert the first power into DC power, and
a second AC/DC converter configured to convert the second power into DC power,
wherein the first AC/DC converter is configured to receive input of the first power that has passed through the first switch, and
wherein the second AC/DC converter is configured to receive input of the second power that has passed through the second switch.

11. The image forming apparatus according to claim 1, wherein the controller is configured to stop, in a case where it is detected that the supply of the first power has been ceased based on the monitoring result obtained by the first monitor and it is detected that the supply of the second power has been ceased based on a monitoring result obtained by the second monitor, the operation of the load, and leave a log in a predetermined memory.

12. A shutdown method at a time of power cut-off, which is executed by an apparatus,
the apparatus including:
a first power cord configured to supply a first power;
a second power cord configured to supply a second power;
a first monitor configured to monitor a supply state of the first power;
a second monitor configured to monitor a supply state of the second power;
a load to which either the first power or the second power can be supplied;
a controller configured to control an operation of the load; and
a switcher configured to be switched between a first state in which the first power is supplied to the controller and a second state in which the second power is supplied to the controller,
the shutdown method comprising stopping, by the controller, in a case where the switcher is in the first state and it is detected that the supply of the first power has been ceased based on a monitoring result obtained by the first monitor, the operation of the load, switching a connection state of the switcher to the second state, supplying the second power to the load, and performing a process associated with cut-off of the first power.
